(19) United States
(12) Patent Application Publication
(10) Pub. No.: US 2006/0097569 A1
(43) Pub. Date: May 11, 2006

(54) Trailer brake status indication

(76) Inventors: Charles E. Eberling, Wellington, OH (US); William P. Amato, Avon, OH (US); Kenneth A. Grolle, Elyria, OH (US); Ron R. Stahl, Medina, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/982,138

(22) Filed: Nov. 5, 2004

(51) Int. Cl. B60T 13/00

(52) U.S. Cl. 303/122.15; 303/9.66; 303/9.63; 303/122.02; 303/123

(57) ABSTRACT

A trailer brake system status indicator is provided to a tractor driver. The status is obtained by sensing the condition of one or more trailer brake system components. The trailer brake component status is used to determine the status of the trailer brake system. The trailer brake status indicator is activated to inform the tractor driver of the trailer brake system status.

### FIELD OF THE INVENTION

The present disclosure relates generally to trailer brake systems, and more particularly, to providing trailer brake system status information to a tractor driver.

### BACKGROUND OF THE INVENTION

The trucking industry has for many years used tractor/trailer combinations to transport cargo over the roadways to intended destinations. The tractor and the trailer are mechanically coupled together so that the tractor can pull the trailer with its cargo in an efficient and cost effective manner. Pneumatic and electrical links between the tractor and the trailer provide a trailer brake system with power and control signals that operate the trailer brake system.

Trailer air brake systems include brake assemblies, brake chambers, and an air reservoir. The brake assemblies are coupled to the trailer wheels. The brake chambers are coupled to the brake assemblies for selectively engaging and disengaging the brake assemblies to stop rotation of the trailer wheels. The reservoir stores air under pressure provided by the tractor via the pneumatic links. The air under pressure is selectively provided to the brake chambers.

Antilock braking components have been added to trailer brake systems to reduce wheel lock during aggressive braking. Trailer antilock braking components include a controller, a modulator, and wheel speed sensors. The wheel speed sensors provide wheel speed information to the controller. The modulators are typically solenoid operated on/off air valves that are controlled by the controller. The controller selectively opens and closes the modulator valves to control the air brake system.

Some antilock braking controllers produce data signals which indicate various conditions of the antilock braking components. These data signals may include a failure warning signal which indicates that the antilock controller detects a failure within the controller itself or a failure of other antilock components. The failure warning signal may drive an antilock braking component indicator that alerts the driver that one of the antilock braking components has failed.

### SUMMARY

The present application relates to providing trailer brake system status information to a tractor driver. The trailer brake system may include antilock components and brake system components that are controlled by the antilock components. According to one method, trailer antilock component faults and brake system status information are provided to a driver. In the method, one or more conditions of the trailer antilock component are monitored. An antilock component fault indicator is provided when a fault condition of an antilock component is detected. A condition of at least one brake system component is sensed. A status of the trailer brake system is determined based on the sensed condition of the at least one brake system component. An indication of the status of the trailer brake system is provided to the driver. For example, an indication that pressure in a trailer reservoir is low, an indication that the trailer parking brake has been left on, and/or an indication that the trailer brakes are not engaging at the time the driver intends the trailer brakes to engage.

The indication of the trailer brake system status may be provided to the driver in a wide variety of different ways. For example, the status may be relayed to the driver via a status indicator that is located on a tractor dashboard or mounted on an area of the trailer that is visible to the driver.

In one embodiment, an antilock braking controller is used to determine the status of the brake system components. The antilock braking controller may be used in a trailer antilock brake system that includes antilock components, brake system components that are controlled by the antilock components, a brake system component sensor, and a trailer brake system status indicator. One example of a controller includes, an input, and a logic applying arrangement. The logic applying arrangement may comprise a memory and a processor. The input receives input signals from the brake system component sensor. A brake system status algorithm is stored in the memory. The processor applies the brake system status algorithm to the input signals to derive output signals that represent a status of the trailer brake system. The output provides the output signals to a status indicator to provide an indication of the status of the trailer brake system to the driver. In one embodiment, the logic applying arrangement comprises a switch network. In one embodiment, the memory for storing the brake systems status algorithm is programmable and the memory for storing braking related control parameters is non-volatile memory.

Trailer brake system status information may be provided to a tractor driver by a trailer antilock brake system that includes a pneumatic brake chamber, a reservoir, a modulator, a wheel speed sensor, a brake component sensor, and a controller. The pneumatic brake chamber selectively engages and disengages a trailer brake. The reservoir stores air under pressure. The modulator selectively supplies the air under pressure to the brake chamber to engage and disengage the trailer brake under the control of the driver. The wheel speed sensor monitors a speed of a trailer wheel. The brake component sensor is coupled to the brake chamber and/or the reservoir. The controller processes signals from the wheel speed sensor and the brake component sensor. The controller controls the modulator based on signals from the wheel speed sensor to inhibit locking of the brake. The controller processes signals from the brake component sensor to derive output signals that represent a status of at least one of the reservoir and the pneumatic brake chamber.

In one embodiment, the brake component sensor is coupled to the reservoir and the controller provides a low air pressure status output signal when the air pressure is below a predetermined value. In one embodiment, the chamber is a spring brake chamber and the brake component sensor is a pressure sensor coupled to the spring brake chamber. In this embodiment, the controller provides a parking brake engaged status output signal when the pressure sensed by the pressure sensor is below a first predetermined value. In one embodiment, the parking brake engaged output signal is provided when the pressure sensed by the pressure sensor is below the first predetermined value and the speed of the vehicle is above a second predetermined value. In one embodiment, the brake component sensor is coupled to the chamber and provides an application status signal that represents a status of a trailer service brake to the controller. In this embodiment, the controller provides a trailer brake mismatch output signal when the status of the trailer service brake differs from the driver's intended status of the trailer service brake. The driver's intended status of the trailer brakes may be obtained by monitoring a trailer brake light signal or by monitoring an engagement status of the tractor brakes.

In one embodiment, a status of a brake system that does not include antilock components is provided to the driver. For example, a trailer parking brake status may be conveyed to the driver by sensing a trailer parking brake status and a trailer speed. A parking brake engaged status indication is provided to the driver when it is determined that the parking brake is engaged and the speed of the vehicle is above the predetermined value. Another example would be to alert the driver when inconsistency between tractor brake application and trailer brake application occurs.

Further advantages and benefits will become apparent to those skilled in the art after considering the following description and appended claims in conjunction with the accompanying drawings.

### BRIEF DESCRIPTION OF THE DRAWINGS

FIG. 1 is a perspective view of a tractor and a trailer;

FIG. 2 is a schematic illustration of an antilock trailer brake system;

FIG. 3A is a flow chart that illustrates a method of providing a trailer brake status indication;

FIG. 3B includes flow charts that illustrate a method of providing an antilock fault indication and a trailer brake status indication;

FIG. 4A is a schematic illustration of a controller that provides a trailer brake system status signal;

FIG. 4B is a schematic illustration of an antilock controller that provides a trailer brake system status signal;

FIG. 5 is a schematic illustration of an antilock controller that provides a trailer brake system status signal;

FIG. 6 is a flow chart that illustrates a method of providing a low trailer reservoir pressure indicator;

FIG. 7 is a flow chart that illustrates a method of providing a trailer parking brake on indicator;

FIG. 8 is a flow chart that illustrates a method of providing a trailer brake engagement discrepancy indicator;

FIG. 9A is an illustration of a trailer brake status indicator provided on a tractor dashboard; and

FIG. 9B is an illustration of a trailer brake status indicator provided on a trailer.

### DETAILED DESCRIPTION

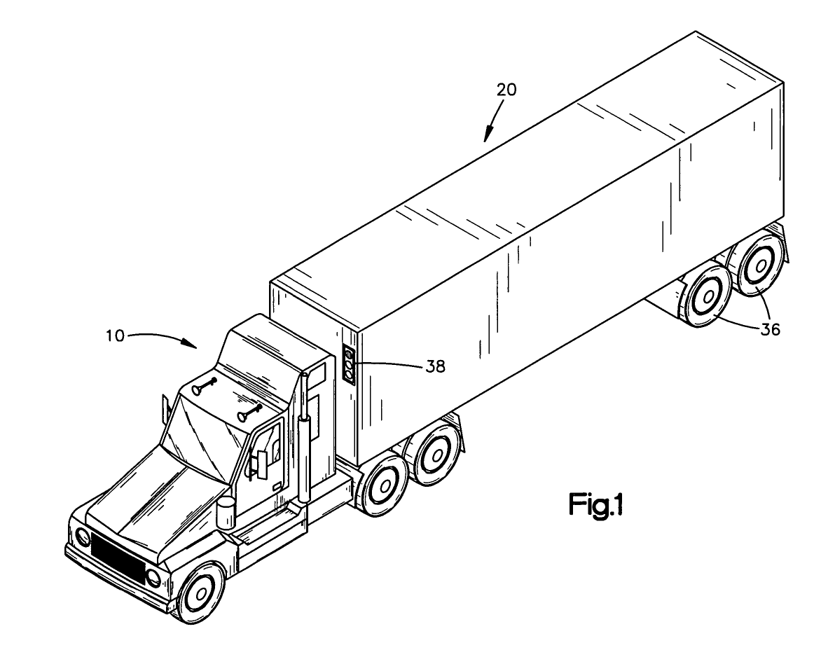

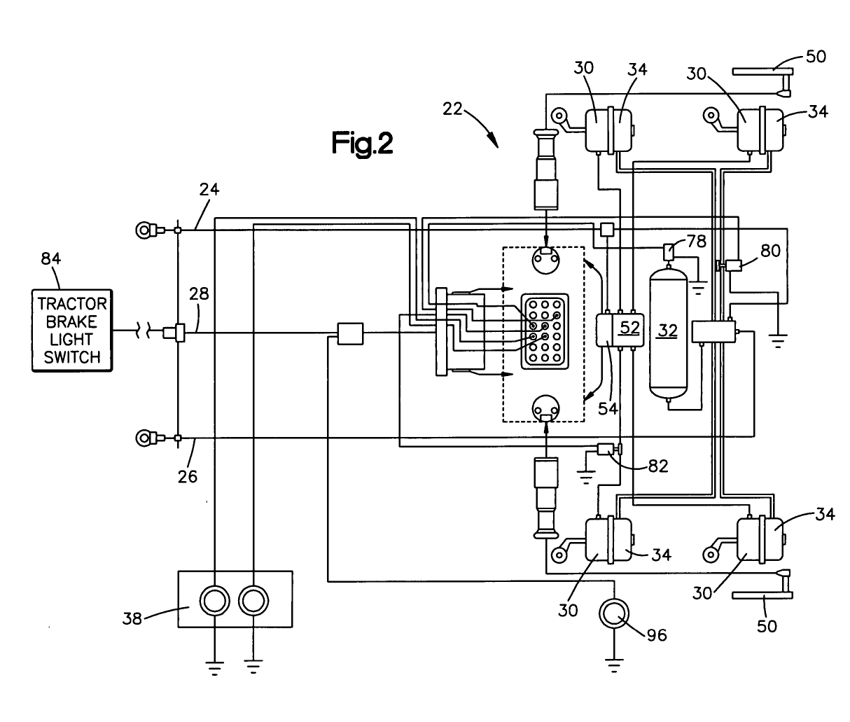

FIG. 1 illustrates a tractor 10 and a trailer 20 that is coupled to the tractor. The coupling allows the tractor to pull the trailer. FIG. 2 illustrates an example of a trailer brake system 22. It should be readily apparent that the trailer brake system 22 illustrated by FIG. 2 is but one example of a wide variety of acceptable brake systems. In the example of FIG. 2, a control line 24, a supply line 26 and an a wiring harness 28 between the tractor 10 and the trailer provide the trailer brake system 22 with power and control signals that operate the trailer brake system. The control line 22 selectively communicates pressurized air to control service brake chambers 30. The supply line 26 supplies a reservoir 32 and controls park brake chambers 34. Brake assemblies (not shown) are coupled to trailer wheels 36 (FIG. 1). The brake chambers 30, 34 are coupled to the brake assemblies for selectively engaging and disengaging the brake

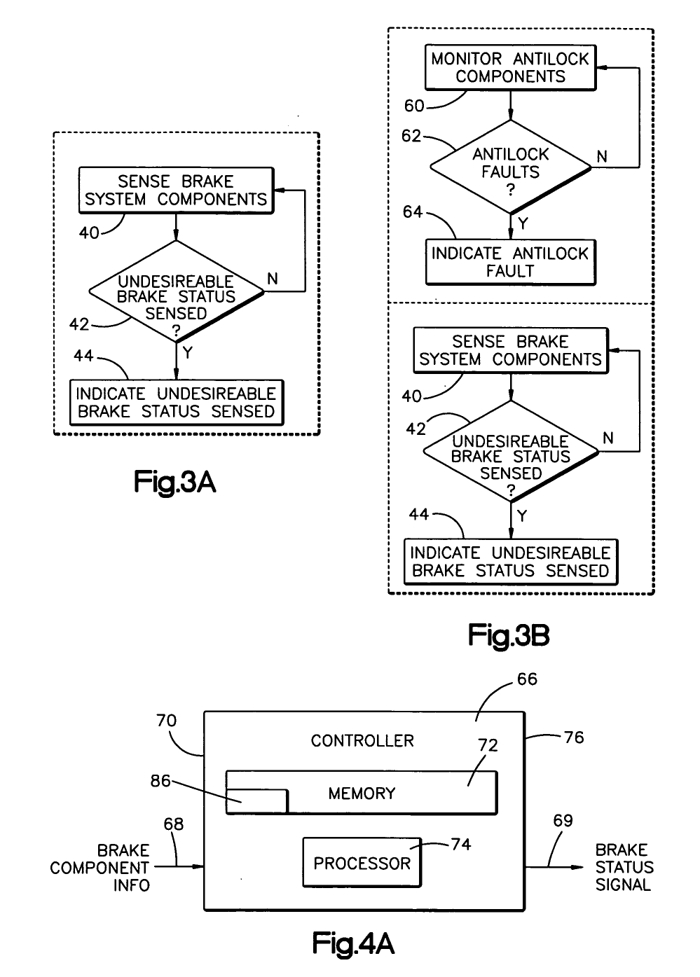

The present application concerns providing trailer brake system status indicator(s) 38 to a tractor driver. FIG. 3A illustrates a method of providing a trailer brake system status indicator 38 (See FIG. 2) to the driver. According to the method, a condition of one or more of the brake system components (chambers 30, 34, reservoir 32, etc.) is sensed 40. The condition of the brake system component(s) is used to determine 42 whether the trailer brake system has an undesirable status. If an undesirable trailer brake system status is sensed, an indicator 38 (FIGS. 1, 2, 9A and B) is provided 44 to the driver that indicates that the trailer brake system is in an undesirable state.

The brake system status indicator(s) 38 may indicate a variety of different trailer brake system conditions to the driver. For example, the status indicator(s) 38 may be provided to notify the driver that the pressure in the trailer brake system reservoir is low, to notify the driver that the trailer parking brakes have been left on and the truck is moving, to notify that the driver that the trailer service brakes are not being applied when the driver intends to apply the trailer service brakes, or to notify the driver that the trailer service brakes are being applied when the driver does not intend to apply the trailer service brakes. The indicator could also provide an indication that one or more of the wheels are locked and the vehicle is moving (ex. a frozen brake).

In the example of FIG. 2, the trailer brake system 22 includes antilock braking components. However, the method illustrated by FIG. 3A could be applied to a brake system that does not include antilock braking components. In the example of FIG. 2, the antilock components control the brake system components. The antilock components include wheel speed sensors 50, a modulator 52 or valve and a controller 54. The controller 54 processes signals from the wheel speed sensor 50 and from the tractor via the wiring harness 28 to control the modulator 52. The modulator selectively supplies the air under pressure to the service brake chambers 30 as directed by the controller to engage and disengage the trailer service brakes.

FIG. 3B illustrates methods that may be performed concurrently when the brake system 22 includes antilock braking components. The concurrently performed methods provide an antilock fault indicator when a fault of an antilock component is detected and a trailer brake system status indicator 38 to the driver. A condition of trailer antilock components (controller 54, wheel speed sensors 50, and modulator 52) is monitored 60 to determine 62 whether there are any antilock component faults. Antilock faults are indicated 64 to the driver. Undesirable trailer brake system state(s) are indicated to the driver in the same manner as described with respect to FIG. 3B.

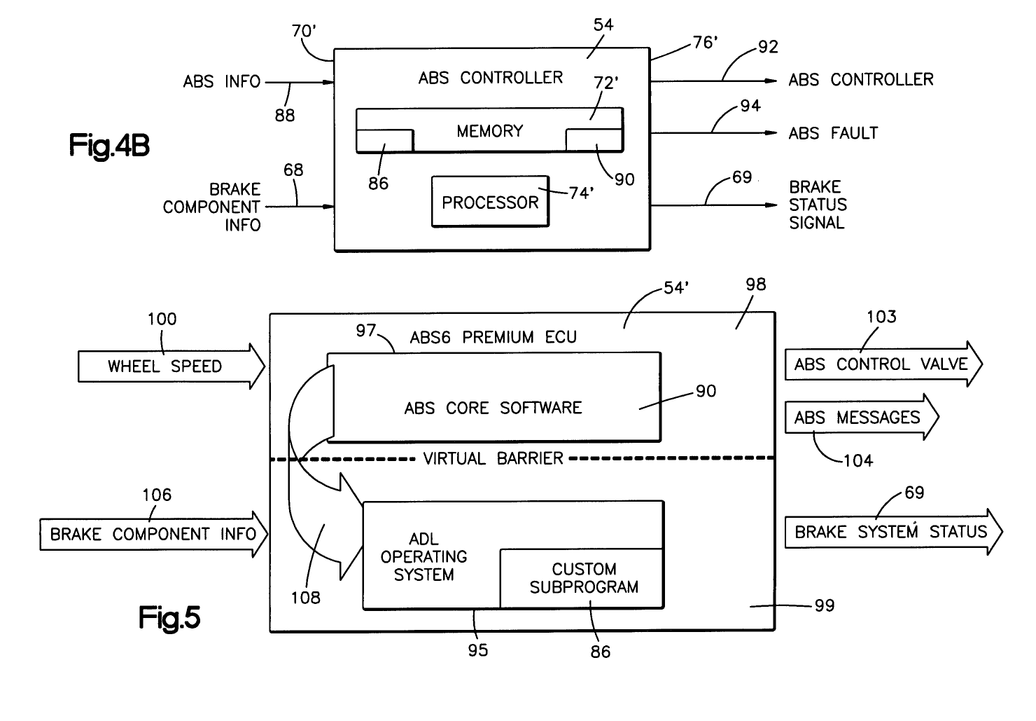

FIG. 4A schematically illustrates a controller 66 that receives brake component information 68 and provides one or more output signals 69 that control the trailer brake status indicator(s) 38. In the exemplary embodiment, a logic applying arrangement derives the output signals 69 based on the component information 68. In the example of FIG. 4A, the logic applying arrangement comprises a memory 72 and a processor 74. The logic applying arrangement could take a variety of different forms. For example, the logic applying arrangement could comprise a switch network.

In the example illustrated by FIG. 4A, an input 70 receives the brake component information 68. The brake component information 68 may be provided to the controller 66 from a variety of different sources. In the example of FIG. 2, a low pressure indicator switch 78 is used to monitor the air pressure in the reservoir 32. A park indicator switch 80 monitors the pressure applied to the park chambers 34. The wheel speed sensors 50 monitor the wheel speed. A trailer brake application indicator switch 82 monitors the air pressure provided to the service chambers 30. A brake light switch 84 monitors the driver's intent regarding the application of the tractor and trailer service brakes. The low pressure indicator switch 78, the park indicator switch 80, trailer brake application indicator switch 82, and/or the brake light switch 84 may provide the brake component information 68 to the controller 66. A temperature sensor could be used to monitor brake temperature. The temperature sensor provides an indication of brake fade

Referring to FIG. 4A, the memory 72 stores a brake system status algorithm 86. The processor 74 applies the brake system status algorithm 86 to the brake component information 68 to derive the output signals 69 that represent a status of the brake system components. An output 76 provides the output signal 69 to the status indicator 38 to provide an indication of the status of the brake system components to the driver. The controller illustrated by FIG. 4A could be used to control the trailer brake system status indicator(s) 38 in an ABS brake system or a brake system that does not include antilock components.

FIG. 4B illustrates an embodiment where a trailer antilock controller 54 is adapted to control the brake status indicator(s) 38, in addition to controlling the antilock components and providing antilock brake fault indicators. The antilock controller 54 includes an input 70′, a memory 72′, a processor 74′, and an output 76′. The input 70′ receives antilock information 88, and brake component information 68. The antilock information 88 may be provided by the wheel speed sensors 50, by the modulator 52, or from the tractor through the wiring harness 28. The memory 72′ stores antilock algorithms 90 and one or more brake system status algorithm 86. The processor 74′ applies the antilock algorithms 90 to the antilock information 88 to derive antilock control signals 92 and applies the antilock algorithms 90 to derive antilock fault signals 94 that are indicative of antilock component faults. The processor 74′ applies the brake system status algorithm 86 to the brake component information 68 to derive the output signals 69 that represent a status of the brake system components. The output 76′ provides the antilock control signal 92 to the modulator 52 to control the air provided to the chambers to inhibit locking of the brake. The output 76′ provides the antilock fault signal 94 to an antilock fault indicator 96 (FIG. 2) that alerts the driver to antilock component faults. The output 76′ provides the output signal 69 to the status indicator(s) 38 to provide an indication of the status of the trailer brake system to the driver.

FIG. 5 illustrates a trailer antilock controller 54′ that includes an antilock control module 98 and a programmable module 99. The programmable module 99 includes programmable memory 95 for storing the brake systems status algorithm 86. The antilock control module 98 includes non-volatile memory 97 for storing the antilock algorithms 90. In the example illustrated by FIG. 5, wheel speed 100 is provided to the antilock algorithms 90 stored in the non-volatile memory 97 to produce antilock control signals 103 and ABS messages 104 are sent to the tractor 10. Brake component information 106 and information 108 read from the antilock control module 98 are applied to the brake system status algorithm 86 to produce brake system status signals 69. In the example illustrated by FIG. 5, data in the antilock control module 98 can only be read by the programmable module 99, to ensure the integrity of the antilock control module. One controller that includes non-volatile storage memory for storing braking related control parameters and discretely programmable storage memory is disclosed in Patent Application Publication No. 2004/0093143 to Fry. The brake system status algorithm 86 could be programmed into the discretely programmable storage memory disclosed by the Fry Patent Application Publication. Patent Application Publication No. 2004/0093143 to Fry is incorporated herein by reference in its entirety.

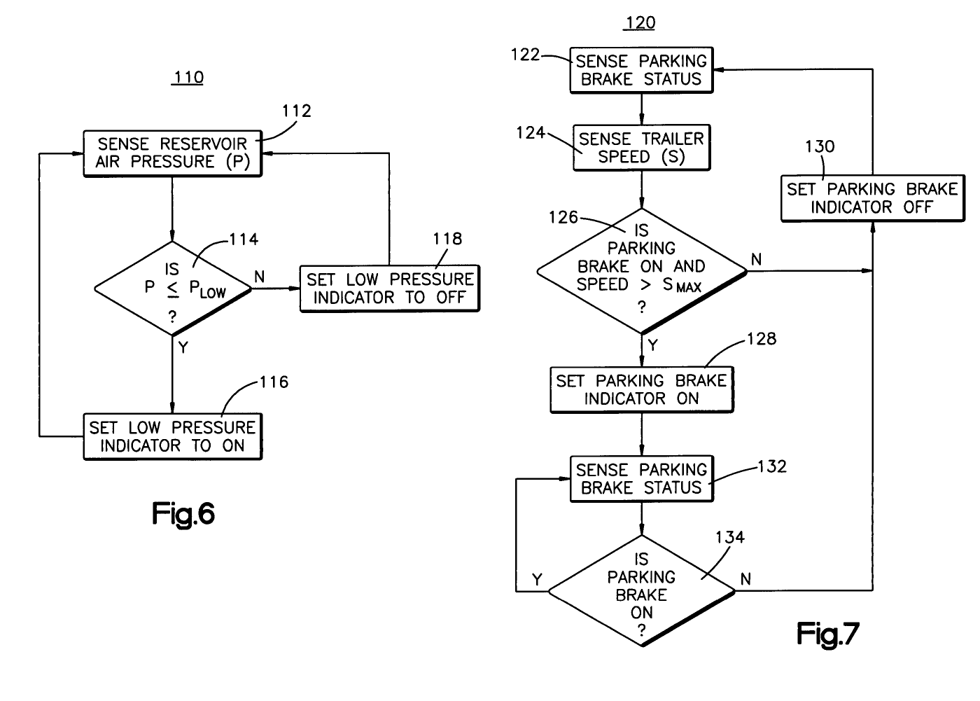

FIGS. 6-8 are flow charts that illustrate examples of brake systems status algorithms 86 that can be used to alert the driver of undesirable trailer brake conditions. A reservoir low air pressure algorithm 110 is illustrated by FIG. 6. Referring to FIGS. 2 and 6, the low air pressure algorithm senses 112 the pressure P in the reservoir 32 and determines 114 whether the pressure in the reservoir 32 is below a threshold pressure PLOW. The threshold pressure depends on the brake system. In one embodiment, the threshold pressure is 60 psi. In the example of FIG. 2, the pressure in the reservoir is sensed with the low pressure indicator switch 78. The low pressure indicator switch 78 provides an indication of the pressure in the reservoir 32 to the trailer antilock controller 54. One type of low pressure indicator switch 78 changes state at the threshold pressure. For example, low pressure switch contacts are open when a pressure greater than the threshold pressure is applied to the switch and the contacts close when the pressure applied to the low pressure switch drops below the threshold pressure. It should be readily apparent that a wide variety of different types of switches or sensors could be used to sense the pressure in the reservoir 32. Referring to FIG. 6, an indicator 38 (Illustrated in FIGS. 1, 2, 9A, and 9B) that represents low pressure in the reservoir is provided 116 to the driver if the pressure P falls below the threshold pressure P_{LOW}. In the exemplary embodiment, the indicator is turned off 118 when the air pressure in the reservoir 32 is restored.

A trailer parking brake algorithm 120 is illustrated by FIG. 7. Referring to FIGS. 2 and 7, the trailer parking brake algorithm 120 senses 122 whether the parking brake is engaged. In the example of FIG. 2, the low pressure indicator switch 80 coupled to the parking brake chamber 34 is used to determine whether the parking brake is engaged. In the example of FIG. 2, the low pressure indicator switch 80 provides an indication of the pressure in the spring brake chamber 34 to the trailer antilock controller 54. The low pressure indicator switch 80 senses whether the pressure applied to the parking brake chamber 34 is below a threshold pressure. A pressurization of the parking brake chamber that is below the threshold value indicates that the parking brakes are engaged. In the example of FIG. 2, the low pressure indicator switch 80 changes state at the pressure value where the parking brakes engage. It should be readily apparent that a wide variety of different types of switches or sensors could be used to sense the pressure in the parking brake chamber 34. Referring to FIG. 7, the trailer parking brake algorithm 120 senses 124 the speed of the trailer wheels. The trailer speed may be obtained in a variety of different ways. In the example of FIG. 2, the speed is obtained from the wheel speed sensors 50. The trailer speed could also be obtained from the tractor, from a global positioning device, or from distinct wheel speed sensors. The trailer parking brake algorithm determines 126 whether the trailer parking brake is on and whether the trailer is moving at a speed above a predetermined speed. The predetermined speed can be any speed that would suggest that the driver has inadvertently left the trailer parking brakes on. For example, the predetermined speed could be ten miles per hour. An indicator 38 (FIGS. 1, 2, 9A and 9B) that represents that the trailer brakes have inadvertently been left on is provided 128 to the driver if the trailer brake parking brake is on and the trailer is moving at a speed above the predetermined speed. If the trailer brake parking brake is off or the trailer is moving at a speed below the predetermined speed, the trailer parking break indicator is off 130. In the example of FIG. 7, the parking break indicator is latched on until the parking brake is turned off, regardless of the speed of the trailer. In the example of FIG. 7, the parking break indicator is latched on by repetitively sensing 132 the parking brake status until the algorithm determines 134 that the parking brakes have been disengaged. In another embodiment, the parking brake indicator is turned on if the trailer brake is on and the trailer is stopped.

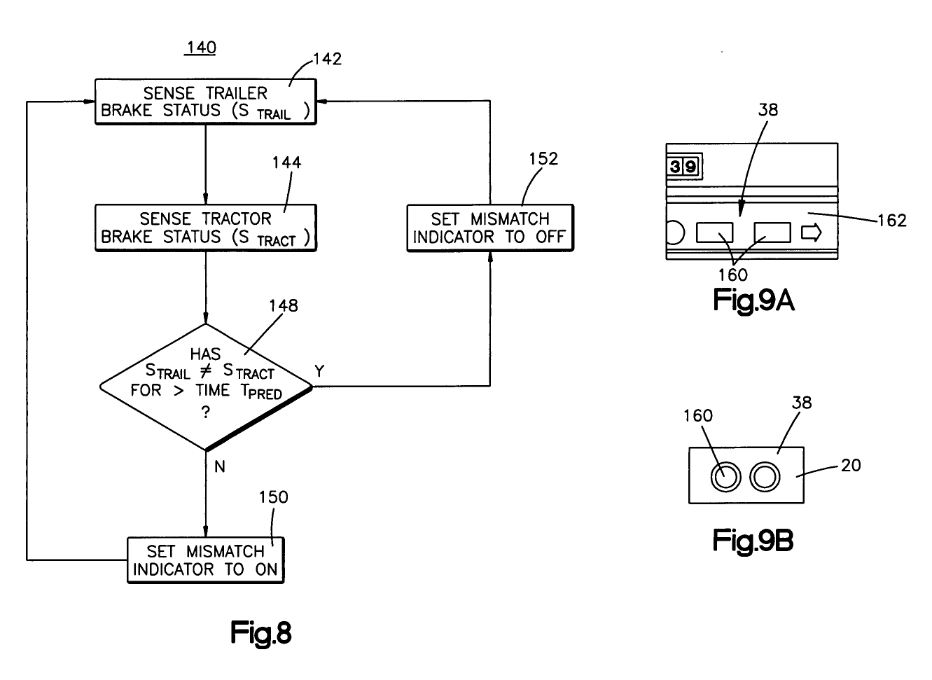

A trailer brake mismatch algorithm 140 is illustrated by FIG. 8. The trailer brake mismatch algorithm 140 alerts the driver if the trailer brakes are not engaged when the driver intends to engage the trailer brakes or the trailer brakes are engaged when the driver does not intend to engage the trailer brakes. Referring to FIGS. 2 and 8, the trailer brake mismatch brake algorithm 140 senses 142 whether the trailer brakes are in an engaged or disengaged state. In the example of FIG. 2, the application indicator switch 82 is used to determine whether or not the trailer service brakes are engaged. The application indicator switch 82 is a pressure sensor coupled to a service brake chamber 30. When the pressure in the service brake chamber is above a predetermined pressure, the service brake chamber applies the brakes. In the example of FIG. 2, the application indicator switch 82 provides an indication of the pressure in the service brake chamber 30 to the trailer antilock controller 54. In the example of FIG. 2, application indicator switch 82 changes state at the pressure value where the service brakes engage. It should be readily apparent that the application of the trailer service brakes could be sensed at a variety of locations by a variety of different types of sensors. For example, a position sensor coupled to the brake assembly could be used to determine whether the brakes are engaged or disengaged. Referring to FIG. 8, the trailer brake mismatch algorithm 140 senses 144 the whether the driver intends for the trailer brakes to be engaged or disengaged. The driver's intent regarding the engagement status of the trailer brakes may be obtained in a variety of different ways. In the example of FIG. 2, the driver's intended status of the trailer brakes is sensed by monitoring the brake light switch 84 on the tractor that is controlled by input from the tractor to turn the trailer brake lights on and off. In another embodiment, the driver's intended status of the trailer brakes is sensed by sensing the status of the tractor brakes, since in most cases (i.e. when the brake pedal causes engagement of the trailer service brakes) the trailer service brakes are engaged when the tractor service brakes are engaged. Monitoring of tractor brake engagement can be performed with a pressure sensor coupled to a tractor brake chamber or a sensor that directly monitors the brake assembly. The trailer brake mismatch algorithm 140 determines 148 whether the status S_{TRAIL} of the trailer brakes does not match the intended status S_{INTEND} of the trailer brakes for longer than a predetermined time T_{PRED}. Referring to FIG. 8, an indicator 38 (FIGS. 1, 2, 9A and 9B) that represents that the status of the trailer service brakes does not match the driver's intended status of the trailer service brakes is provided 150 to the driver if the trailer service brakes are disengaged when the driver intends to engage, or the trailer service brakes are engaged when the driver does not intend to engage the trailer service brakes. In the example illustrated by FIG. 8, the trailer brake mismatch indicator is not applied until the status of the trailer brakes and the driver's intended status of the trailer brakes does not match for a predetermined period of time. The air pressure signal from the tractor through the trailer control line to the trailer brakes is physically slower than the signal provided by the brake light switch 84. By providing the trailer brake mismatch indicator only after the trailer brake status and the driver's intended trailer brake status do not match for a predetermined period of time, the trailer brake mismatch indicator is not inadvertently provided as a result of the trailer brake application lag. In another embodiment, the trailer brake mismatch indicator is provided as soon as a difference is detected. If the both the trailer service brakes are engaged and the driver's intent is that trailer service brakes are engaged, the mismatch indicator is turned off 152. In the exemplary embodiment, the trailer brake application mismatch indicator is latched on until both the tractor service brakes and the trailer service brakes are engaged for a predetermined period of time, such as five seconds.

The trailer brake system status indicator(s) 38 may take a variety of different forms. For example, the indicator could be a visual and/or an audible indicator. In the example of FIG. 9A, the indicator 38 comprises a visual display 160 on a tractor dashboard 162. The trailer brake status signals that drive the visual display 160 may be transmitted from the trailer brake system to the visual display in a variety of different ways. For example, the signals may be communicated over the wiring harness or the communication may be wireless.

In the example of FIG. 2, the trailer brake system status signals 69 are communicated to the tractor over the wiring harness 28. The trailer brake system status signals 69 may be communicated over the power bus conductor in the wiring harness that distributes electrical power to the antilock braking components. U.S. Pat. No. 6,127,939 discloses a method and system that can be used to communicate the trailer brake system status signals from the trailer antilock braking controller to the tractor over the power bus. U.S. Pat. No. 6,127,939 is incorporated herein by reference in its entirety.

In the exemplary embodiment, a tractor controller that drives a dash mounted indicator is compatible with a trailer antilock controller that provides the trailer brake system status signals 69. For example, a tractor antilock controller may drive the indicator in the cab. The tractor antilock controller can receive and process the trailer brake system status signals from the trailer antilock controller if the tractor antilock controller and the trailer antilock controller are compatible.

In the example of FIGS. 1 and 9B, the indicator 38 comprises a visual indicator 160 mounted on the trailer 20 at a position that is visible to the driver. In this embodiment, the trailer brake status signals can be communicated to the indicator, without having to be communicated to the tractor 10.

While the invention has been described with reference to specific embodiments, it will be apparent to those skilled in the art that may alternatives, modifications, and variations may be made. Accordingly, the present invention is intended to embrace all such alternatives, modifications, and variations that may fall within the spirit and scope of the appended claims.

1. A method of providing trailer brake system status information to a driver, comprising:
a) monitoring a condition of trailer antilock components that control trailer brake system pneumatic components with a trailer antilock controller;
b) providing an antilock component fault signal with the trailer antilock controller when a fault condition of an antilock component is detected;
c) sensing a condition of at least one of the trailer brake system pneumatic components with the trailer antilock controller;
d) determining a status of the trailer brake system with the trailer antilock controller based on a sensed condition of the at least one of the trailer brake system pneumatic components; and
e) providing an indication of the status of the trailer brake system to the driver.

2. The method of claim 1 wherein the trailer brake system pneumatic components comprise an air reservoir and wherein a signal indicative of an air pressure in the reservoir is provided to the trailer antilock controller and a low air pressure status signal is provided by the trailer antilock controller when the air pressure is below a predetermined value.

3. The method of claim 1 wherein the trailer brake system pneumatic components comprise a parking brake and wherein a status of a parking brake is sensed, a speed of the vehicle is sensed and the trailer antilock controller provides a parking brake engaged status signal when the parking brake is engaged and the speed of the vehicle is above a predetermined value.

4. The method of claim 1 wherein the trailer brake system pneumatic components comprise a service brake and wherein an application status of a trailer service brake is sensed, driver intent regarding application of the trailer service brake is sensed, and the trailer antilock controller provides a trailer brake mismatch status signal when the status of the trailer service brake differs from the sensed driver intent.

5. The method of claim 1 wherein an indicator that provides the status of the trailer brake system to the driver is located on a tractor dashboard.

6. The method of claim 1 wherein an indicator that provides the status of the trailer brake system to the driver is mounted on a trailer at a position that is visible to the driver.

7. The method of claim 1 wherein a signal that represents the sensed condition of the at least one of the brake components is provided to an antilock braking controller, the antilock braking controller processes the signal to determine the status of the trailer brake system, and the antilock braking controller provides the status indicator to the driver.

8. An antilock braking controller for a trailer antilock brake system that includes antilock components, brake system pneumatic components that are controlled by the antilock components, at least one sensor coupled to at least one of the brake system pneumatic components, and a brake system component status indicator, the controller comprising:
a) an input for receiving input signals from the at least one sensor that senses a condition of a pneumatic brake system component;
b) memory for storing a brake system status algorithm;
c) a processor for applying the brake system status algorithm to the input signals to derive output signals that represent a status of the brake system pneumatic components;
d) an output for providing the output signal to the status indicator to provide an indication of the status of the brake system pneumatic components to a driver.

9. The antilock braking controller of claim 8 wherein the input signal represents air pressure in a reservoir and the controller provides a low air pressure status output signal when the air pressure is below a predetermined value.

10. The antilock braking controller of claim 8 wherein the input signal represents a status of a parking brake, a vehicle speed signal is provided to the controller, and the controller provides a parking brake engaged status output signal when the parking brake is engaged and the speed of the vehicle is above a predetermined value.

11. The antilock braking controller of claim 8 wherein the input signal represents a status of a trailer service brake, an application status signal that represents a status of a tractor service brake is provided to the controller, and the controller provides a trailer brake mismatch output signal when the status of the trailer service brake differs from the status of the tractor service brake.

12. The antilock braking controller of claim 8 wherein the memory for storing the brake systems status algorithm is programmable and wherein memory for storing braking related control parameters is non-volatile memory.

13. The antilock braking controller of claim 8 wherein the controller includes a control module for processing antilock algorithms to derive antilock component control signals and a programmable module for processing the brake systems status algorithm to derive the output signals that represent a status of the brake system components.

14. The antilock braking controller of claim 13 wherein data from the control module is provided to the programmable module and data from the programmable module is isolated from the control module.

15. A trailer antilock brake system comprising:
a) a pneumatic brake chamber for selectively engaging and disengaging a trailer brake;
b) a reservoir for storing air under pressure;
c) a modulator that selectively supplies the air under pressure to the brake chamber to engage and disengage the trailer brake;
d) a wheel speed sensor for monitoring a speed of a trailer wheel;
e) a brake component sensor coupled to at least one of the brake chamber and the reservoir;
f) a trailer antilock brake controller that processes signals from the wheel speed sensor and the brake component sensor, wherein the controller controls the modulator based on signals from the wheel speed sensor to inhibit locking of the brake, and wherein the controller processes signals from the brake component sensor to derive output signals that represent a status of at least one of the reservoir and the pneumatic brake chamber.

16. (canceled)

17. The trailer antilock brake system of claim 15 wherein the brake chamber is a parking brake chamber and the brake component sensor is a pressure sensor coupled to the parking brake chamber, and wherein the controller provides a parking brake engaged status output signal when the pressure sensed by the pressure sensor is below a first predetermined value and the speed of the vehicle is above a second predetermined value.

18. The trailer antilock brake system of claim 15 wherein the brake component sensor is coupled to the chamber and an application status signal that represents a driver intent regarding application of a trailer service brake is provided to the controller, wherein the controller provides a trailer brake mismatch output signal when the status of the trailer service brake differs from the driver intent.

19. A trailer antilock brake system comprising:
a) an actuation means for selectively engaging and disengaging a trailer brake;
b) a storage means for storing air under pressure;
c) a supply means for selectively supplying the air under pressure to the actuation means to engage and disengage the trailer brake;
d) a wheel speed sensing means for monitoring a speed of a trailer wheel;
e) a brake component sensing means for sensing a status of at least one of the actuation means and the storage means; and
f) a control means for processing signals from the wheel speed sensing means and the brake component sensing means, wherein the control means controls the supply means based on signals from the wheel speed sensing means to inhibit locking of the trailer brake, and wherein the control means processes signals from the brake component sensing means to derive output signals that represent a status of at least one of the actuation means and the storage means.

20. The trailer antilock brake system of claim 19 wherein the brake component sensing means senses an air pressure in the storage means and the control means provides a low air pressure status indicator to a driver when the air pressure is below a predetermined value.

21. The trailer antilock brake system of claim 19 wherein the brake component sensing means senses a parking brake status, and the control means provides a parking brake engaged status indicator to a driver when the parking brake is engaged and the speed of the vehicle is above a predetermined value.

22. The trailer antilock brake system of claim 19 wherein the brake component sensing means senses a status of a trailer service brake, a driver intent regarding an application status of a trailer service brake is provided to the control means, and the control mean provides a trailer brake mismatch status indicator to the driver when the status of the trailer service brake differs from the driver intent.

23. A method of indicating a trailer parking brake status to a driver, comprising:
a) sensing a trailer parking brake engagement status;
b) sensing a trailer speed;
c) determining whether the trailer parking brake is engaged and the speed of the trailer is above a predetermined value;
d) providing a trailer parking brake engaged status indication to the driver after determining that the parking brake is engaged and the speed of the vehicle is above the predetermined value.

24. The method of claim 23 further comprising maintaining the parking brake engaged status indicator until the parking brake status changes to disengaged.

25. The method of claim 23 wherein the trailer brake parking status is sensed by monitoring a pressure applied to a parking brake chamber.

26. A method of indicating an inconsistency between a driver intended with regard to tractor brake application and trailer brake application to a driver, comprising:
a) determining whether trailer brakes are engaged;
b) determining whether the driver intends that the tractor brakes be engaged;
c) providing a trailer brake inconsistency indicator to the driver when the driver intends that the trailer brakes be engaged and the trailer brakes are disengaged or the driver intends that the tractor brakes be disengaged and the trailer brakes are engaged.

27. The method of claim 26 further comprising determining whether the tractor brakes and the trailer brakes are engaged for more than a predetermined period of time and resetting the trailer brake inconsistency indicator when the trailer brakes and the tractor brakes are engaged for more the predetermined period of time.

28. The method of claim 26 wherein engagement of the trailer service brake is sensed by monitoring a pressure applied to a trailer service brake chamber and the driver intent for the trailer service brake is sensed by a sensing a status of a brake light switch.

29. The method of claim 26 wherein the inconsistency indicator is provided when the trailer service brakes are engaged and the driver intends to leave the brakes in a disengaged state.

30. An antilock braking controller for a trailer antilock brake system that includes antilock components, and brake system components, including an air reservoir, a parking brake, and a service brake, that are controlled by the antilock components, the controller comprising:
a) means for receiving input signals that represent a status of air pressure in the reservoir, a status of the parking brake, a vehicle speed, a status of the service brake, and a status of a driver controlled trailer service brake actuator; and
b) means for applying a brake system status algorithm to the input signals to derive a low air pressure status output signal when the air pressure in the reservoir is below a predetermined value, a parking brake engaged status output signal when the parking brake is engaged and the speed of the vehicle is above a predetermined value, and a trailer brake mismatch output signal when the status of the trailer service brake differs from the status of a driver controlled trailer service brake actuator.

31. (canceled)

32. (canceled)

33. (canceled)

34. An antilock braking controller for a trailer antilock brake system that includes antilock components, and brake system components, including an air reservoir, a parking brake, and a service brake, that are controlled by the antilock components, the controller comprising:
a) an input for receiving input signals that represent a status of air pressure in the reservoir, a status of the parking brake, a vehicle speed, a status of the service brake, and a status of a driver controlled trailer service brake actuator; and
b) a logic applying arrangement for applying a brake system status algorithm to the input signals to derive a low air pressure status output signal when the air pressure in the reservoir is below a predetermined value a parking brake engaged status output signal when the parking brake is engaged and the speed of the vehicle is above a predetermined value, and a trailer brake mismatch output signal when the status of the trailer service brake differs from the status of a driver controlled trailer service brake actuator.

35. (canceled)

36. (canceled)

37. (canceled)

38. A method of providing trailer brake status information to a driver comprising:
a) sensing a status of a parking brake;
b) sensing a status of a service brake;
c) sensing a status of a service brake actuator;
d) sensing a pressure in a brake system reservoir;
e) sensing a speed of a wheel of the trailer;
f) inhibiting brake locking based on the speed of the wheel; and
g) providing an alert of an undesirable trailer brake condition to the driver when the pressure in the reservoir is below a predetermined value, when the parking brake is engaged and the speed of the vehicle is above a predetermined value, and when the status of the trailer service brake differs from the status of the service brake actuator.

39. A method of providing trailer brake status information to a driver comprising:
a) sensing a status of a parking brake with a trailer antilock controller;
b) sensing a status of a service brake with the trailer antilock controller;
c) sensing a status of a service brake actuator with the trailer antilock controller;
d) sensing a pressure in a brake system reservoir with the trailer antilock controller;
e) sensing a speed of a wheel of the trailer with the trailer antilock controller;
f) inhibiting brake locking based on the speed of the wheel with the trailer antilock controller; and
g) providing an alert of an undesirable trailer brake condition with the trailer antilock controller to the driver when the pressure in the reservoir is below a predetermined value, when the parking brake is engaged and the speed of the vehicle is above a predetermined value, and when the status of the trailer service brake differs from the status of the service brake actuator.

40. A method of providing trailer brake status information to a driver comprising:
a) sensing a status of a parking brake;
b) sensing a status of a service brake;
c) sensing a status of a service brake actuator;
d) sensing a pressure in a brake system reservoir;
e) sensing a speed of a wheel of the trailer;
f) inhibiting brake locking based on the speed of the wheel;
g) providing a low air pressure status indicator to the driver when the pressure in the reservoir is below a predetermined value;
h) providing a parking brake engaged status indicator to the driver when the parking brake is engaged and the speed of the vehicle is above a predetermined value; and
i) providing a trailer brake mismatch status indicator to the driver when the status of the trailer service brake differs from the status of the service brake actuator.

41. A method of providing trailer brake status information to a driver comprising:
a) sensing a status of a parking brake with a trailer antilock controller;
b) sensing a status of a service brake with the trailer antilock controller;
c) sensing a status of a service brake actuator with the trailer antilock controller;
d) sensing a pressure in a brake system reservoir with the trailer antilock controller;
e) sensing a speed of a wheel of the trailer with the trailer antilock controller;
f) inhibiting brake locking based on the speed of the wheel with the trailer antilock controller;
g) providing a low air pressure status indicator to the driver with the trailer antilock controller when the pressure in the reservoir is below a predetermined value;
h) providing a parking brake engaged status indicator to the driver with the trailer antilock controller when the parking brake is engaged and the speed of the vehicle is above a predetermined value; and
i) providing a trailer brake mismatch status indicator to the driver with the trailer antilock controller when the status of the trailer service brake differs from the status of the service brake actuator.

42. A trailer antilock brake system comprising:
a) a pneumatic trailer parking brake;
b) a parking brake sensor coupled to the pneumatic parking brake for sensing a status of the parking brake;
c) a pneumatic trailer service brake;
d) a service brake sensor coupled to the pneumatic service brake for sensing a status of the service brake;
e) a service brake actuator for selectively actuating the service brake;
f) a service brake actuator sensor arranged to sense a status of the service brake actuator;
g) a reservoir for storing air under pressure;
h) a reservoir sensor for sensing a pressure in the reservoir;
i) a modulator that selectively supplies the air under pressure to the trailer service brake to selectively actuate the trailer service brake;
j) a wheel speed sensor for monitoring a wheel speed of the trailer;
k) a trailer antilock controller that processes signals from the wheel speed sensor, the parking brake sensor, the service brake sensor, and the reservoir sensor, wherein the controller controls the modulator based on signals from the wheel speed sensor to inhibit locking of the brake, and wherein the controller provides an undesirable trailer brake condition signal when the air pressure in the reservoir is below a predetermined value, when the parking brake is engaged and the speed of the vehicle is above a predetermined value, and when the status of the trailer service brake differs from the status of the service brake actuator.

43. A trailer antilock brake system comprising:
a) a pneumatic trailer parking brake;
b) a parking brake sensor coupled to the pneumatic parking brake for sensing a status of the parking brake;
c) a pneumatic trailer service brake;
d) a service brake sensor coupled to the pneumatic service brake for sensing a status of the service brake;
e) a service brake actuator for selectively actuating the service brake;
f) a service brake actuator sensor arranged to sense a status of the service brake actuator;
g) a reservoir for storing air under pressure;
h) a reservoir sensor for sensing a pressure in the reservoir;
i) a modulator that selectively supplies the air under pressure to the trailer service brake to selectively actuate the trailer service brake;
j) a wheel speed sensor for monitoring a wheel speed of the trailer;
k) a trailer antilock controller that processes signals from the wheel speed sensor, the parking brake sensor, the service brake sensor, and the reservoir sensor, wherein the controller controls the modulator based on signals from the wheel speed sensor to inhibit locking of the brake, and wherein the controller provides a low air pressure status output signal when the air pressure in the reservoir is below a predetermined value, a parking brake engaged status output signal when the parking brake is engaged and the speed of the vehicle is above a predetermined value, and a trailer brake mismatch output signal when the status of the trailer service brake differs from the status of the service brake actuator.

43. An antilock braking controller for a trailer antilock brake system that includes antilock components, and brake system components, including an air reservoir, a parking brake, and a service brake, that are controlled by the antilock components, the controller comprising:
a) an input for receiving input signals that represent a status of air pressure in the reservoir, a status of the parking break, a vehicle speed, a status of the service brake, and a status of a driver controlled trailer service brake actuator; and
b) a logic applying arrangement for applying a brake system status algorithm to the input signals to derive an undesirable trailer brake condition signal when the air pressure in the reservoir is below a predetermined value, when the parking brake is engaged and the speed of the vehicle is above a predetermined value, and when the status of the trailer service brake differs from the status of a driver controlled trailer service brake actuator.
